(19) United States
(12) Patent Application Publication
(10) Pub. No.: US 2026/0011501 A1
(43) Pub. Date: Jan. 8, 2026

(54) MULTILAYER CERAMIC CAPACITOR

(71) Applicant: Murata Manufacturing Co., Ltd., Nagaokakyo-shi (JP)

(72) Inventors: Hideyuki HASHIMOTO, Nagaokakyo-shi (JP); Kenji UENO, Nagaokakyo-shi (JP); Shinya ISOTA, Nagaokakyo-shi (JP)

(21) Appl. No.: 19/322,792

(22) Filed: Sep. 9, 2025

Related U.S. Application Data
(63) Continuation of application No. PCT/JP2024/011609, filed on Mar. 25, 2024.

(30) Foreign Application Priority Data
Mar. 27, 2023 (JP) 2023-050663
Mar. 27, 2023 (JP) 2023-050664
Mar. 27, 2023 (JP) 2023-050665
Mar. 27, 2023 (JP) 2023-050666

(51) Int. Cl. H01G 4/30; H01G 4/12

(52) U.S. Cl. CPC H01G 4/30; H01G 4/1209

(57) ABSTRACT

A multilayer ceramic capacitor includes a multilayer body including dielectric layers, inner electrode layers, first and second main surfaces facing each other in a height direction, first and second side surfaces facing each other in a width direction perpendicular or substantially perpendicular to the height direction, and first and second end surfaces facing each other in a length direction perpendicular or substantially perpendicular to the height direction and the width direction, and an outer electrode layer on the multilayer body and connected to some of the inner electrode layers. When crystal orientations of crystal grains in the dielectric layers are measured by electron backscatter diffraction, two or more pairs of adjacent crystal grains between which a difference in crystal orientation is within about 5 degrees with respect to a predetermined direction in a 2 μm-square observation area are present.

### CROSS REFERENCE TO RELATED APPLICATIONS

This application claims the benefit of priority to Japanese Patent Application Nos. 2023-050666, 2023-050665, 2023-050664 and 2023-050663 each filed on Mar. 27, 2023 and is a Continuation Application of PCT Application No. PCT/JP2024/011609 filed on Mar. 25, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

In recent years, multilayer ceramic capacitors have been used in electronic equipment requiring a high permittivity and high reliability, such as compact in-vehicle devices. Japanese Unexamined Patent Application Publication No. 2017-228590 describes a technique for improving the performance of a multilayer ceramic capacitor by adjusting the distribution of nickel near grain boundaries and other factors.

However, the technique described in Japanese Unexamined Patent Application Publication No. 2017-228590 may be insufficient to improve electrical characteristics or reliability.

### SUMMARY OF THE INVENTION

Example embodiments of the present invention provide multilayer ceramic capacitors each with improved mechanical strength.

A multilayer ceramic capacitor according to an example embodiment of the present invention includes a multilayer body including a plurality of stacked dielectric layers, a plurality of stacked inner electrode layers, a first main surface and a second main surface facing each other in a height direction, a first side surface and a second side surface facing each other in a width direction perpendicular or substantially perpendicular to the height direction, and a first end surface and a second end surface facing each other in a length direction perpendicular substantially perpendicular to the height direction and the width direction, and an outer electrode layer on the multilayer body and connected to some of the plurality of inner electrode layers, wherein, when crystal orientations of crystal grains in the plurality of dielectric layers are measured by electron backscatter diffraction, two or more pairs of adjacent crystal grains between which a difference in crystal orientation is within about 5 degrees with respect to a predetermined direction in a about 2 μm-square observation area are present.

According to example embodiments of the present invention, multilayer ceramic capacitors each with improved mechanical strength are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic capacitor according to a first example embodiment of the present invention.

FIG. 2 is a cross-sectional view taken along line I-I of FIG. 1.

FIG. 3 is a cross-sectional view taken along line II-II of FIG. 1.

FIG. 4A is an image quality map showing the crystal grains observed in an Example of the first example embodiment of the present invention.

FIG. 4B is a crystal orientation map generated based on FIG. 4A.

FIG. 5A is an image quality map showing the crystal grains observed in a Comparative Example of the first example embodiment of the present invention.

FIG. 5B is a crystal orientation map generated based on FIG. 5A.

FIG. 6A is a graph showing the peak diffraction angle in Example of a second example embodiment of the present invention.

FIG. 6B is a graph showing the peak diffraction angle in a Comparative Example of a second example embodiment of the present invention.

FIG. 7A illustrates the observation result obtained by high-angle annular dark-field scanning transmission electron microscopy when the (100) crystal plane is observed.

FIG. 7B illustrates the observation result obtained by high-angle annular dark-field scanning transmission electron microscopy when the (100) crystal plane is observed.

FIG. 7C illustrates the observation result obtained by high-angle annular dark-field scanning transmission electron microscopy when the (100) crystal plane is observed.

FIG. 7D illustrates the observation result obtained by high-angle annular dark-field scanning transmission electron microscopy when the (100) crystal plane is observed.

FIG. 7E illustrates the observation result obtained by high-angle annular dark-field scanning transmission electron microscopy when the (100) crystal plane is observed.

FIG. 7F illustrates the observation result obtained by high-angle annular dark-field scanning transmission electron microscopy when the (100) crystal plane is observed.

FIG. 7G illustrates the observation result obtained by high-angle annular dark-field scanning transmission electron microscopy when the (100) crystal plane is observed.

FIG. 7H illustrates the observation result obtained by high-angle annular dark-field scanning transmission electron microscopy when the (100) crystal plane is not observed.

FIG. 8 illustrates how observations are conducted by high-angle annular dark-field scanning transmission electron microscopy.

### DETAILED DESCRIPTION OF THE EXAMPLE EMBODIMENTS

Example embodiments of the present invention will be described below with reference to the drawings.

### First Example Embodiment

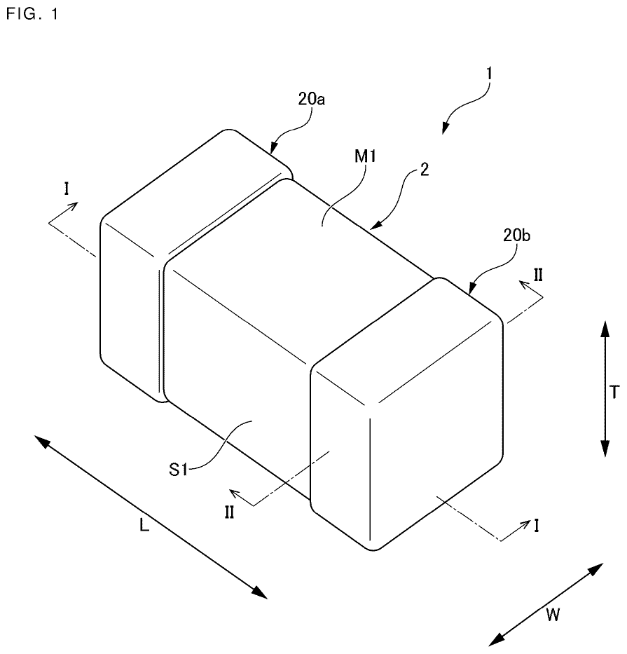

A first example embodiment of the present invention will be described with reference to FIG. 1. FIG. 1 is a perspective view of a multilayer ceramic capacitor 1 according to a first example embodiment of the present invention. FIG. 1 illustrates a two-terminal multilayer ceramic capacitor. Multilayer ceramic capacitors according to example embodiments of the present invention are not limited to a two-terminal multilayer ceramic capacitor. Multilayer ceramic capacitors according to example embodiments of the present invention may be multiterminal multilayer ceramic capacitors, such as a three-terminal multilayer ceramic capacitor, for example.

### Multilayer Body

A multilayer body 2 includes a plurality of dielectric layers and a plurality of inner electrode layers stacked on top of one another. The multilayer body 2 has a rectangular or substantially rectangular parallelepiped shape.

The direction in which the dielectric layers and the inner electrode layers are stacked on top of one another in the multilayer body 2 is the height direction T. The direction perpendicular or substantially perpendicular to the height direction T is the width direction W. The direction perpendicular or substantially perpendicular to the height direction T and the width direction W is the length direction L.

One of the two surfaces of the multilayer body 2 facing each other in the height direction T is a first main surface M1. The remaining one surface is a second main surface M2. One of the two surfaces of the multilayer body 2 facing each other in the width direction W is a first side surface S1. The remaining one surface is a second side surface S2. One of the two surfaces of the multilayer body 2 facing each other in the length direction L is a first end surface E1. The remaining one surface is a second end surface E2.

The cross-section of the multilayer body 2 taken along line I-I of FIG. 1 is referred to as an LT cross-section. The cross-section of the multilayer body 2 taken along line II-II of FIG. 1 is referred to as a WT cross-section.

The intersection of three surfaces of the multilayer body 2 is referred to as a corner of the multilayer body 2. The intersection of two surfaces of the multilayer body 2 is referred to as an edge of the multilayer body 2. The corners and edges are preferably rounded.

### Dielectric Layer

The total number of the dielectric layers stacked in the multilayer body 2 is, for example, preferably 15 or more and 2, 000 or less. The main material of the dielectric layers is a ceramic material. The ceramic material is, for example, a dielectric ceramic including, as a main component, barium titanate, calcium titanate, strontium titanate, calcium zirconate, or other components. The ceramic material may be, for example, a dielectric ceramic including, in addition to the main component, a secondary component, such as a manganese compound, an iron compound, a chromium compound, a cobalt compound, or a nickel compound.

The dielectric layers include crystal grains. The crystal grains define and function as the main component of the dielectric layers and include, for example, a perovskite oxide including an A-site element and a B-site element. The perovskite oxide has a composition represented by the general formula: ABO₃. Each atom of the A-site element and each atom of the B-site element are ionized and respectively occupy the A-sites and B-sites of the perovskite structure. Examples of the A-site element include elements with relatively large ionic sizes, such as barium, calcium, or strontium. Examples of the B-site element include elements with relatively small ionic sizes, such as titanium, zirconium, or hafnium.

The combination of the A-site element and the B-site element is not limited as long as the perovskite structure is maintained. Each of the A-site element and the B-site element may include only one element or a combination of multiple elements.

Preferably, for example, the A-site element includes barium, and the B-site element includes titanium. In other words, the perovskite oxide is, for example, preferably a barium titanate compound.

The thickness of one layer of the dielectric layers is, for example, preferably about 0.3 μm or more and about 10 μm or less.

### Segments of Multilayer Body

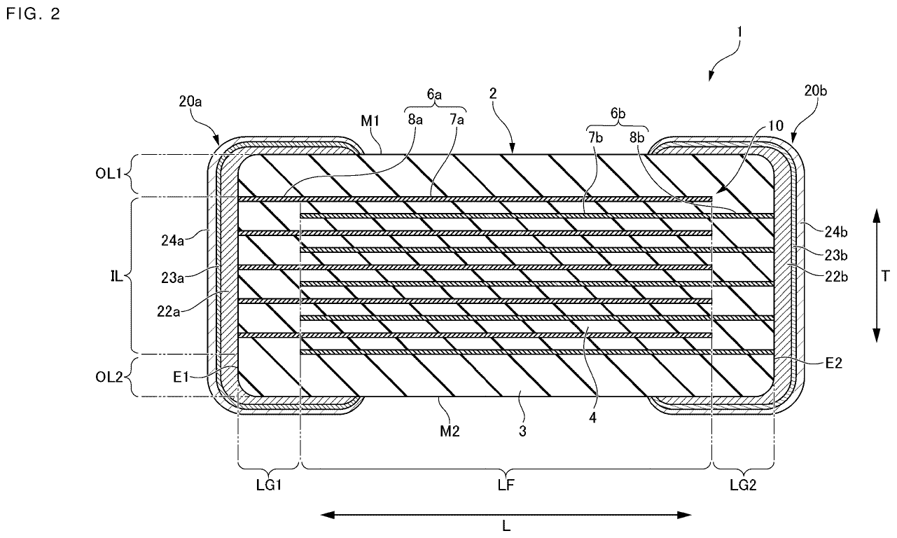

The segments of the multilayer body 2 in the length direction L will be described with reference to FIG. 2. FIG. 2 is a cross-sectional view taken along line I-I of FIG. 1. The multilayer body 2 can be divided into a first main surface-side outer layer portion OL1, an inner layer region IL, and a second main surface-side outer layer portion OL2 in the height direction T. The first main surface-side outer layer portion OL1, the inner layer region IL, and the second main surface-side outer layer portion OL2 are arranged in this order in the height direction T from the first main surface M1 to the second main surface M2.

The first main surface-side outer layer portion OL1 is a portion between the first main surface M1 and the inner electrode layer closest to the first main surface M1. The inner layer region IL is a region where the inner electrode layers face one another. The second main surface-side outer layer portion OL2 is a portion between the second main surface M2 and the inner electrode layer closest to the second main surface M2.

The first main surface-side outer layer portion OL1 is located on the first main surface M1 side of the multilayer body 2. The first main surface-side outer layer portion OL1 includes an assembly of multiple dielectric layers located between the first main surface M1 and the inner electrode layer closest to the first main surface M1. The first main surface-side outer layer portion OL1 includes a plurality of dielectric layers located between the first main surface M1 and the outermost surface in the inner layer region IL on the first main surface M1 side and between the first main surface M1 and the extension of the outermost surface.

The second main surface-side outer layer portion OL2 is located on the second main surface M2 side of the multilayer body 2. The second main surface-side outer layer portion OL2 includes an assembly of multiple dielectric layers located between the second main surface M2 and the inner electrode layer closest to the second main surface M2. The second main surface-side outer layer portion OL2 includes a plurality of dielectric layers located between the second main surface M2 and the outermost surface in the inner layer region IL on the second main surface M2 side and between the second main surface M2 and the extension of the outermost surface.

The inner layer region IL is sandwiched between the first main surface-side outer layer portion OL1 and the second main surface-side outer layer portion OL2.

Of the dielectric layers, the dielectric layers disposed in the first main surface-side outer layer portion OL1 and the second main surface-side outer layer portion OL2 are referred to as outer dielectric layers 3. Of the dielectric layers, the dielectric layers disposed in the inner layer region IL are referred to as inner dielectric layers 4.

The following terms may be used to describe dimension and position.

The dimension in the length direction L is referred to as the lengthwise dimension. The dimension in the width direction W is referred to as the widthwise dimension. The dimension in the height direction T is referred to as the heightwise dimension.

The midpoint of the lengthwise dimension is referred to as the center position in the length direction L. The center position in the length direction L is referred to as the lengthwise center position.

The midpoint of the widthwise dimension is referred to as the center position in the width direction W. The center position in the width direction W is referred to as the widthwise center position.

The midpoint of the heightwise dimension is referred to as the center position in the height direction T. The center position in the height direction T is referred to as the heightwise center position.

An end in the length direction L is referred to as a lengthwise end. An end in the width direction W is referred to as a widthwise end. An end in the height direction T is referred to as a heightwise end.

The multilayer body 2 may have any suitable size. The lengthwise dimension of the multilayer body is, for example, preferably about 0.2 mm or more and about 10 mm or less. The widthwise dimension of the multilayer body 2 is, for example, preferably about 0.1 mm or more and about 5 mm or less. The heightwise dimension of the multilayer body 2 is, for example, preferably about 0.1 mm or more and about 5 mm or less.

### L Gap

The segments of the multilayer body 2 in the length direction L will be described. The multilayer body 2 can be divided into a first end surface-side outer layer portion LG1, a length direction counter portion LF, and a second end surface-side outer layer portion LG2 in the length direction L. The first end surface-side outer layer portion LG1, the length direction counter portion LF, and the second end surface-side outer layer portion LG2 are arranged in this order in the length direction L from the first end surface E1 to the second end surface E2.

The length direction counter portion LF is a portion where the inner electrode layers face one another in the height direction T. The first end surface-side outer layer portion LG1 is a portion between the length direction counter portion LF and the first end surface E1. The second end surface-side outer layer portion LG2 is a portion between the length direction counter portion LF and the second end surface E2. The length direction counter portion LF is a portion corresponding to the counter electrode portions of the inner electrode layers. The first end surface-side outer layer portion LG1 and the second end surface-side outer layer portion LG2 are portions corresponding to the extended electrode portions of the inner electrode layers. The first end surface-side outer layer portion LG1 and the second end surface-side outer layer portion LG2 are also referred to as L gaps.

The counter electrode portions includes first counter electrode portions 7a and second counter electrode portions 7b. The extended electrode portions include first extended electrode portions 8a and second extended electrode portions 8b. The counter electrode portions and the extended electrode portions will be described below.

The first end surface-side outer layer portion LG1 is located on the first end surface E1 side. The first end surface-side outer layer portion LG1 is located between the first end surface E1 and the first end surface E1 side-ends of second inner electrode layers 6b.

The second end surface-side outer layer portion LG2 is located on the second end surface E2 side. The second end surface-side outer layer portion LG2 is located between the second end surface E2 and the second end surface E2 side-ends of first inner electrode layers 6a.

### W Gap

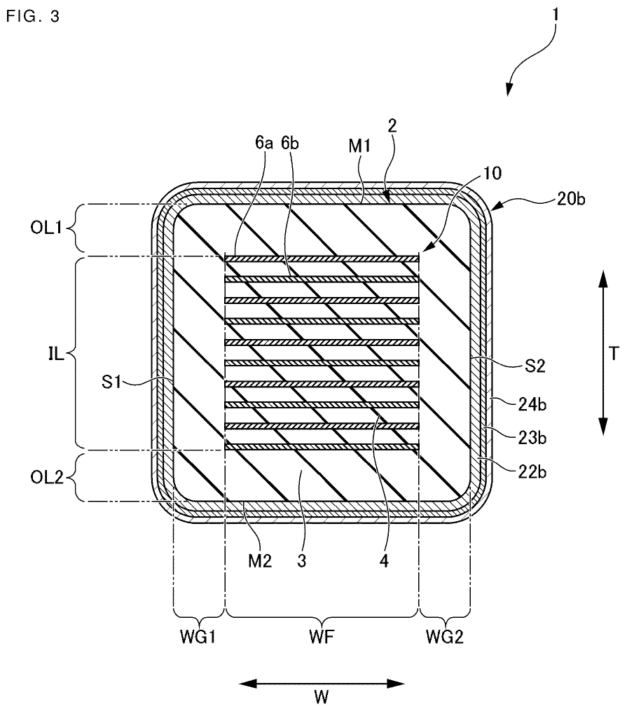

The segments of the multilayer body 2 in the width direction W will be described with reference to FIG. 3. FIG. 3 is a cross-sectional view taken along line II-II of FIG. 1. The multilayer body 2 can be divided into a first side surface-side outer layer portion WG1, a width direction counter portion WF, and a second side surface-side outer layer portion WG2 in the width direction W. The first side surface-side outer layer portion WG1, the width direction counter portion WF, and the second side surface-side outer layer portion WG2 are arranged in this order in the width direction W from the first side surface S1 to the second side surface S2.

The width direction counter portion WF is a portion where the inner electrode layers face one another in the height direction T. The first side surface-side outer layer portion WG1 is a portion between the width direction counter portion WF and the first side surface S1. The second side surface-side outer layer portion WG2 is a portion between the width direction counter portion WF and the second side surface S2. The first side surface-side outer layer portion WG1 and the second side surface-side outer layer portion WG2 are also referred to as W gaps.

The first side surface-side outer layer portion WG1 and the second side surface-side outer layer portion WG2 are portions where no inner electrode layers are present in the height direction T. The first side surface-side outer layer portion WG1 is located on the first side surface S1 side.

The second side surface-side outer layer portion WG2 is located on the second side surface S2 side. The second side surface-side outer layer portion WG2 is formed by a plurality of dielectric layers located between the second side surface S2 and the outermost surface of the width direction counter portion WF on the second side surface S2 side.

### Inner Electrode Layer

The inner electrode layers include a plurality of first inner electrode layers 6a and a plurality of second inner electrode layers 6b. The first inner electrode layers 6a are inner electrode layers exposed on the first end surface E1. The second inner electrode layers 6b are inner electrode layers exposed on the second end surface E2.

Each first inner electrode layer 6a can be divided into a first counter electrode portion 7a and a first extended electrode portion 8a. The first counter electrode portions 7a face the second inner electrode layers 6b. Each first extended electrode portion 8a extends from the corresponding first counter electrode portion 7a to the first end surface E1 of the multilayer body 2.

Each first extended electrode portion 8a includes a first end surface E1-side end extending to the surface of the first end surface E1 of the multilayer body 2. The end of each first extended electrode portion 8a extending to the first end surface E1 is exposed on the first end surface E1.

Each second inner electrode layer 6b can be divided into the second counter electrode portion 7b and the second extended electrode portion 8b. The second counter electrode portions 7b face the first inner electrode layers 6a. Each second extended electrode portion 8b extends from the corresponding second counter electrode portion 7b to the second end surface E2 of the multilayer body 2.

Each second extended electrode portion 8b includes a second end surface E2-side end extending to the surface of the second end surface E2 of the multilayer body 2. The end of each second extended electrode portion 8b extending to the second end surface E2 is exposed on the second end surface E2.

The material of the first inner electrode layers 6a and the second inner electrode layers 6b may be, for example, a metal, such as nickel, copper, silver, palladium, or gold. The material of the first inner electrode layers 6a and the second inner electrode layers 6b may be, for example, an alloy including at least one of the metals described above, such as a silver-palladium alloy.

In the multilayer ceramic capacitor 1, the first counter electrode portions 7a face the second counter electrode portions 7b with a corresponding one of the inner dielectric layers 4 interposed therebetween to form capacitance. Having such a configuration, the multilayer ceramic capacitor 1 has the characteristics of the capacitor.

The first inner electrode layers 6a and the second inner electrode layers 6b preferably have a thickness of, for example, about 0.2 μm or more and about 2.0 μm or less. The total number of the first inner electrode layers 6a and the second inner electrode layers 6b is, for example, preferably 15 or more and 2,000 or less.

### Inner Layer Portion

A portion where the first inner electrode layers 6a face the second inner electrode layers 6b is referred to as an inner layer portion 10. The inner layer portion 10 is a portion where the length direction counter portion LF illustrated in FIG. 2 and the width direction counter portion WF illustrated in FIG. 3 intersect the inner layer region IL. The inner layer portion 10 has a rectangular or substantially rectangular parallelepiped shape. In FIG. 2, a portion where the length direction counter portion LF intersects the inner layer region IL is illustrated as the inner layer portion 10. In FIG. 3, a portion where the width direction counter portion WF intersects the inner layer region IL is illustrated as the inner layer portion 10.

### Outer Electrode

Outer electrodes will be described. The outer electrodes include a first outer electrode 20a and a second outer electrode 20b. The first outer electrode 20a is an outer electrode connected to the first inner electrode layers 6a. The second outer electrode 20b is an outer electrode connected to the second inner electrode layers 6b.

The first outer electrode 20a is disposed on the first end surface E1, a portion of the first main surface M1, a portion of the second main surface M2, a portion of the first side surface S1, and a portion of the second side surface S2. The second outer electrode 20b is disposed on the second end surface E2, a portion of the first main surface M1, a portion of the second main surface M2, a portion of the first side surface S1, and a portion of the second side surface S2.

Each outer electrode includes a base electrode layer and a plating layer. The plating layer includes, for example, a Ni-plating layer and a Sn-plating layer. The base electrode layer, the Ni-plating layer, and the Sn-plating layer are arranged in this order, starting from the end surface of the multilayer body 2.

The first outer electrode 20a includes, for example, a first base electrode layer 22a, a first Ni-plating layer 23a, and a first Sn-plating layer 24a. The second outer electrode 20b includes, for example, a second base electrode layer 22b, a second Ni-plating layer 23b, and a second Sn-plating layer 24b.

### Base Electrode Layer

The first base electrode layer 22a is disposed on the first end surface E1 of the multilayer body 2 to cover the first end surface E1. The first base electrode layer 22a extends from the first end surface E1 to a portion of the first main surface M1, a portion of the second main surface M2, a portion of the first side surface S1, and a portion of the second side surface S2.

The second base electrode layer 22b is disposed on the second end surface E2 of the multilayer body 2 to cover the second end surface E2. The second base electrode layer 22b extends from the second end surface E2 to a portion of the first main surface M1, a portion of the second main surface M2, a portion of the first side surface S1, and a portion of the second side surface S2.

The base electrode layer includes a glass component and a metal. The glass component includes, for example, at least one of B, Si, Ba, Mg, Al, Li, or other elements. The metal includes, for example, at least one of Cu, Ni, Ag, Pd, an Ag—Pd alloy, Au, or other elements.

### Ni-Plating Layer and Sn-Plating Layer

The first Ni-plating layer 23a is disposed to cover the first base electrode layer 22a. The first Sn-plating layer 24a is disposed to cover the first Ni-plating layer 23a.

The second Ni-plating layer 23b is disposed to cover the second base electrode layer 22b. The second Sn-plating layer 24b is disposed to cover the second Ni-plating layer 23b.

The Ni-plating layers can prevent the base electrode layers from being eroded by solder during the mounting of the multilayer ceramic capacitor 1. The Sn-plating layers can improve solder wettability during the mounting of the multilayer ceramic capacitor 1 and can facilitate the mounting process.

A conductive resin layer can be provided between each base electrode layer and the corresponding Ni-plating layer. The conductive resin layer can include, for example, an epoxy resin and a metal filler.

The multilayer ceramic capacitor 1 may have any size. The multilayer ceramic capacitor 1 including the multilayer body 2 and the outer electrodes preferably has a lengthwise dimension of, for example, about 0.2 mm or more and about 10 mm or less. The multilayer ceramic capacitor 1 including the multilayer body 2 and the outer electrodes preferably has a heightwise dimension of, for example, about 0.1 mm or more and about 5 mm or less. The multilayer ceramic capacitor 1 including the multilayer body 2 and the outer electrodes preferably has a widthwise dimension of, for example, about 0.1 mm or more and about 10 mm or less.

### Method for Manufacturing Multilayer Ceramic Capacitor

An example of a method for manufacturing the multilayer ceramic capacitor 1 will be described below.

(1) Dielectric sheets and a conductive paste for the inner electrode layers are prepared. The dielectric sheets and the conductive paste for the inner electrode layers include a binder and a solvent. The binder and the solvent may be, for example, any known organic binder and organic solvent.

(2) The conductive paste for the inner electrode layers is applied in a predetermined pattern onto the dielectric sheets. The application of the conductive paste forms an inner electrode layer pattern. The conductive paste can be applied by, for example, screen printing, gravure printing, or other methods.

(3) A predetermined number of dielectric sheets for the outer layer portions are stacked on top of one another. The inner electrode layer pattern is not printed on the dielectric sheets for the outer layer portions. On the stacked dielectric sheets, the dielectric sheets with the inner electrode layer pattern printed thereon are stacked sequentially. On top of that, a predetermined number of the dielectric sheets for the outer layer portions are further stacked. A multilayer sheet is produced through this stacking process.

(4) The multilayer sheet is pressed in the height direction to produce a multilayer block. The pressing method may be, for example, isostatic pressing.

(5) The multilayer block is cut into a predetermined size. A multilayer chip is cut out through this cutting process. In the cutting process, the corners and edges of the multilayer chip may be rounded. The corners and edges can be rounded by barrel polishing, for example.

(6) The multilayer chip is fired. This firing process produces a multilayer body. The firing temperature is, for example, preferably about 900° C. or higher and about 1200° C. or lower. The firing temperature can be changed according to the materials of the dielectric layers and the inner electrode layers.

The cooling after heating to the firing temperature is faster than natural cooling. For example, the multilayer chip is cooled from a firing temperature of about 900° C. or higher and about 1200° C. or lower to a temperature of about 100° C. or higher and about 300° C. or lower within about 10 minutes. Preferably, for example, the multilayer chip is cooled from about 1000° C. to about 200° C. within about 7 minutes. More preferably, for example, the multilayer chip is cooled from about 1000° C. to about 200° C. within about 5 minutes. Even more preferably, for example, the multilayer chip is cooled from about 1000° C. to about 200° C. within about 1 minute.

This cooling process can improve productivity compared to natural cooling in which the multilayer chip is simply left to stand.

The cooling in this process does not mean simply placing the multilayer chip in a gas at a predetermined temperature. The cooling means more actively cooling the multilayer chip. For example, the multilayer chip can be sprayed with a gas at a predetermined temperature. Alternatively, for example, a solid or liquid at a predetermined temperature can be brought into contact with the multilayer chip.

### Outer Electrode

Next, the outer electrodes are formed. First, a conductive paste, which will form the base electrode layers, is applied to two end surfaces of the multilayer body 2. The conductive paste includes, for example, a glass component and a metal component. The conductive paste can be applied by, for example, dipping or other methods. After the application, the conductive paste is baked to form the base electrode layers. The baking temperature is, for example, preferably about 500° C. or higher and about 900° C. or lower. The baking time is, for example, preferably about 30 minutes or more and about 2 hours or less.

Next, the Ni-plating layer is formed on each of the surfaces of the base electrode layers. The Sn-plating layer is further formed on each of the surfaces of the Ni-plating layers. The Ni-plating layers and the Sn-plating layers can be formed by, for example, barrel plating or other methods. The multilayer ceramic capacitor 1 is produced accordingly.

The crystal orientation of the crystal grains of the dielectric layers in the multilayer ceramic capacitor 1 of the first example embodiment will be described.

### Crystal Orientation

In adjacent crystal grains of the dielectric layers in the multilayer ceramic capacitor 1 of the first example embodiment, there are many pairs or sets of crystal grains whose crystal orientations are close to each other. The crystal orientations obtained from electron backscatter diffraction (EBSD) patterns will be described below.

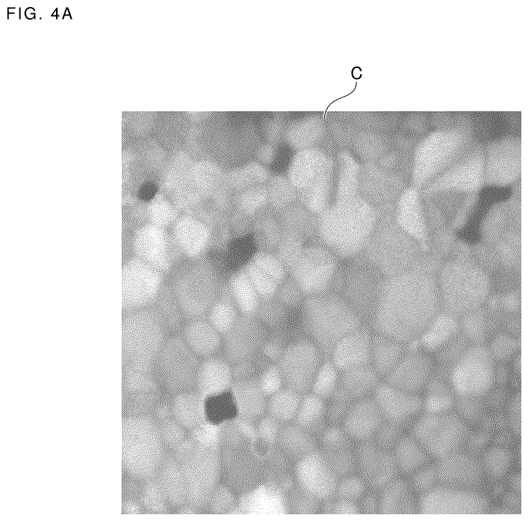

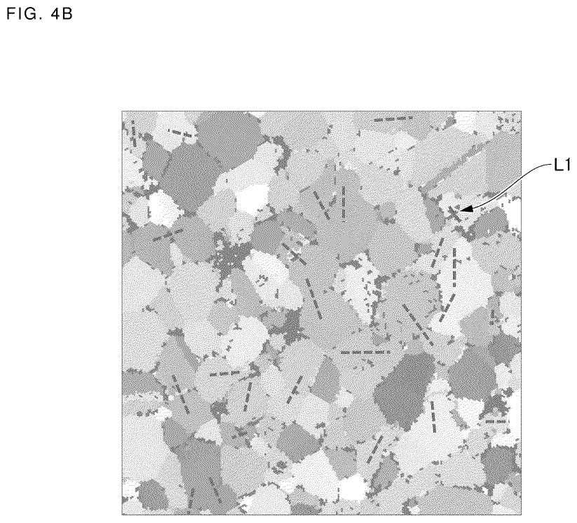

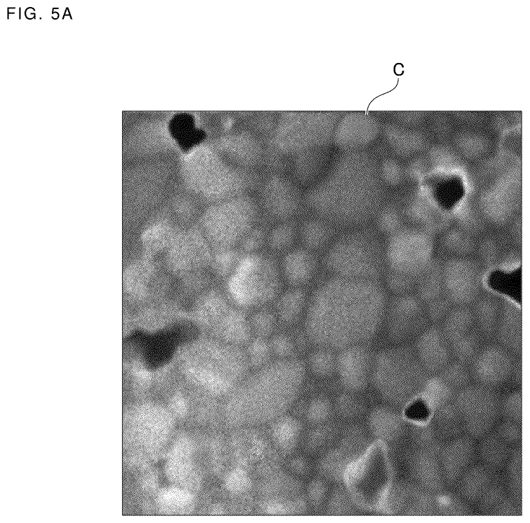

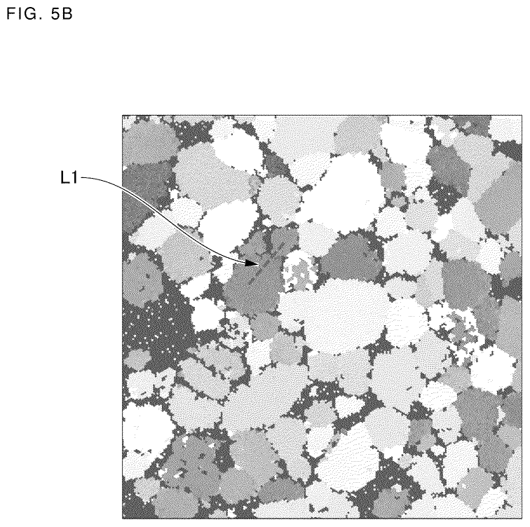

FIGS. 4A and 4B illustrate Example of the first example embodiment, and FIGS. 5A and 5B illustrate Comparative Example of the first example embodiment. FIGS. 4A and 5B are image quality maps illustrating the crystal grains C observed in the normal direction (ND) by electron backscatter diffraction.

FIG. 4B is a crystal orientation map generated based on the image quality map illustrated in FIG. 4A. Similarly, FIG. 5B is a crystal orientation map generated based on the image quality map illustrated in FIG. 5A. The crystal orientation map is also called the inverse pole figure (IPF) map.

In Example of the first example embodiment and Comparative Example of the first example embodiment illustrated in FIGS. 4A and 4B and FIGS. 5A and 5B, the sample as described below was subjected to electron backscatter diffraction. The multilayer ceramic capacitor is polished to expose the surface of the sample. Polishing is performed by grinding the surface that is parallel or substantially parallel to the width direction W and the height direction T. The surface of the sample is the WT cross-section at the center position in the length direction T.

The crystal orientation was measured in the outer layer portions. This is because the crystal orientation is strongly correlated with cracks occurring in the outer layer portions.

The measurement by electron backscatter diffraction was performed using a thin section sample. The WT cross-section of the multilayer ceramic capacitor at the center position in the length direction T, as described above, was processed into a thin section sample before the measurement. Specifically, the WT cross-section was measured after the surface opposite the measurement surface was polished to a sample thickness of about 100 nm.

In the outer layer portions, the area for measuring the crystal orientation is about 2 μm square. The number of crystal grains included in this observation area is typically 50 or more and 250 or less.

In the crystal orientation maps illustrated in FIGS. 4B and 5B, dashed lines L1 are marked at the grain boundaries between two adjacent crystal grains between which the difference in crystal orientation is within 5 degrees with respect to a predetermined direction.

In Example of the first example embodiment as illustrated in FIG. 4B, there are 24 pairs of adjacent crystal grains between which the difference in crystal orientation is within about 5 degrees with respect to a predetermined direction in the measurement area illustrated in FIG. 4B.

In Comparative Example of the first example embodiment, there is a pair of such adjacent crystal grains as illustrated in FIG. 5B.

In addition, in Example of the first example embodiment, there are four sets of three crystal grains including one crystal grain and two crystal grains that are adjacent to the crystal grain and whose misorientation angles with respect to the crystal grain are within about 5 degrees. In Comparative Example of the first example embodiment, there is no set of such three crystal grains.

As described above, in the dielectric layers in the multilayer ceramic capacitor 1 of the first example embodiment, there are many pairs or sets of crystal grains whose crystal orientations are close to each other.

The proportion of the crystal grains each of which is in contact with another crystal grain whose difference in crystal orientation from the corresponding crystal grain is within about 5 degrees with respect to a predetermined direction in all crystal grains is also higher in the multilayer ceramic capacitor 1 of the first example embodiment than in conventional multilayer ceramic capacitors. In the multilayer ceramic capacitor 1 of the first example embodiment illustrated in FIG. 4B, 45 of the 166 total crystal grains were each in contact with another crystal grain whose difference in crystal orientation was within about 5 degrees with respect to a predetermined direction. The proportion was about 27.1%. In Comparative Example of the first example embodiment illustrated in FIGS. 5B, two of the 113 total crystal grains were each in contact with another crystal grain whose difference in crystal orientation was within about 5 degrees with respect to a predetermined direction. The proportion was about 1.8%.

The occurrence of cracks in the outer layer portions of the multilayer ceramic capacitors of Example of the first example embodiment and Comparative Example of the first example embodiment was evaluated.

The evaluation method and evaluation criteria for crack occurrence are as described below. Ten multilayer ceramic capacitors were subjected to the flexural test in accordance with the method specified in JIS C 6484, and the presence or absence of cracks in the dielectric layers was evaluated when the deflection was fixed at about 5 mm.

No cracks were observed in the multilayer ceramic capacitor of Example of the first example embodiment, whereas cracks were observed in the multilayer ceramic capacitor of Comparative Example of the first example embodiment.

### Measurement Method

The length, thickness, and other properties of each a portion can be measured as described below, for example. The multilayer ceramic capacitor 1 is polished to a widthwise center position. The cross-section exposed by polishing is then observed with an optical microscope or other devices. The length, thickness, and other properties can be measured from the observed cross-section.

### Second Example Embodiment

A multilayer ceramic capacitor 1 of a second example embodiment of the present invention will be described. The following description focuses mainly on the differences from the first example embodiment. Matters not specifically described can be the same or substantially the same as those in the first example embodiment.

The technique described in Japanese Unexamined Patent Application Publication No. 2017-228590 may be insufficient to improve electrical characteristics or reliability. The second example embodiment is directed to a multilayer ceramic capacitor with higher relative permittivity.

A multilayer ceramic capacitor according to the second example embodiment includes a multilayer body including a plurality of stacked dielectric layers, a plurality of stacked inner electrode layers, a first main surface and a second main surface facing each other in a height direction, a first side surface and a second side surface facing each other in a width direction perpendicular or substantially perpendicular to the height direction, and a first end surface and a second end surface facing each other in a length direction perpendicular or substantially perpendicular to the height direction and the width direction, and an outer electrode layer disposed on the multilayer body and connected to some of the inner electrode layers, wherein a difference between a first peak diffraction angle and a second peak diffraction angle is about 0.023 degrees or more, when the X-ray diffraction intensity of the dielectric layers in a cross-section of the multilayer body that is parallel or substantially parallel to the width direction and the height direction is measured by an X-ray stress measurement method, the width direction is defined as the azimuth angle of about 0 degrees, the leftward direction is defined as the positive direction of the azimuth angle, the diffraction angle at which the X-ray diffraction intensity reaches a maximum when the angle of incidence of X-rays is changed from a sample to a direction of the normal to the sample at an azimuth angle of about 30 degrees is defined as a first peak diffraction angle, and the diffraction angle at which the X-ray diffraction intensity reaches its maximum when the angle of incidence of X-rays is changed from the sample to the direction of the normal to the sample at an azimuth angle of about 90 degrees is defined as a second peak diffraction angle.

According to the multilayer ceramic capacitor of the second example embodiment, a multilayer ceramic capacitor with higher relative permittivity can be provided.

The characteristics of the dielectric layers in a multilayer ceramic capacitor 1 of the second example embodiment will be described.

### Peak Diffraction Angle

The peak diffraction angle will be described below. In the dielectric layers in the multilayer ceramic capacitor 1 of the second example embodiment, the peak diffraction angle varies depending on the azimuth angle measured. Peak diffraction angle refers to the diffraction angle at which the X-ray diffraction intensity reaches its maximum.

The peak diffraction angle can be measured by the X-ray stress measurement method. The X-ray stress measurement method is as described in the journal “Zairyo” (J. Soc. Mat. Sci., Japan), Vol. 47, No. 11, pp. 1188-1194 November 1998 and the like.

In the X-ray stress measurement method, a sample is irradiated with X-rays, and the diffracted X-rays from the sample are detected. The angle between the direction of X-ray irradiation onto the sample and the direction of emission of the diffracted X-rays from the sample is the diffraction angle. The diffraction angle is equal to about twice the Bragg angle.

The diffracted X-rays are detected while the angle of X-ray irradiation onto the sample is being changed. The angle of X-ray irradiation onto the sample can be changed by changing the irradiation direction from the direction of the normal to the sample surface to the direction parallel or substantially parallel to the sample surface. Alternatively, the angle of X-ray irradiation onto the sample can be changed by changing the irradiation direction from the direction parallel or substantially parallel to the sample surface to the direction of the normal to the sample surface.

The irradiation angle at which the intensity of diffracted X-rays from the (222) crystal plane of BaTiO₃ reaches a maximum is determined while the angle of X-ray irradiation onto the sample is being changed. This irradiation angle is the peak diffraction angle.

The peak diffraction angle can be measured while the azimuth angle is being changed. The azimuth angle is the direction in which the X-ray irradiation angle is changed. In other words, the azimuth angle is the direction in which the irradiation direction is tilted when the irradiation direction is changed from the direction of the normal to the sample surface to the direction parallel or substantially parallel to the sample surface.

The sample used for the peak diffraction angle measurement will be described. The multilayer ceramic capacitor is polished to expose the surface of the sample. Polishing is performed by, for example, grinding the surface that is parallel or substantially parallel to the width direction W and the height direction T. The surface of the sample is the WT cross-section at the center position in the length direction T.

A circular region with a diameter of about 500 μm in a central a portion of the WT cross-section is a region irradiated with X-rays. The inner layer region IL of the multilayer body 2 is a measurement area.

The width direction W in the WT cross-section is defined as the azimuth angle of about 0 degrees. The leftward direction from the width direction W is defined as the positive direction of the azimuth angle.

The diffraction angle at which the X-ray diffraction intensity reaches a maximum when the angle of incidence of X-rays is changed from the sample surface to the direction of the normal to the sample surface at an azimuth angle of about 30 degrees is defined as a first peak diffraction angle. The diffraction angle at which the X-ray diffraction intensity reaches a maximum when the angle of incidence of X-rays is changed from the sample surface to the direction of the normal to the sample surface at an azimuth angle of about 90 degrees is defined as a second peak diffraction angle.

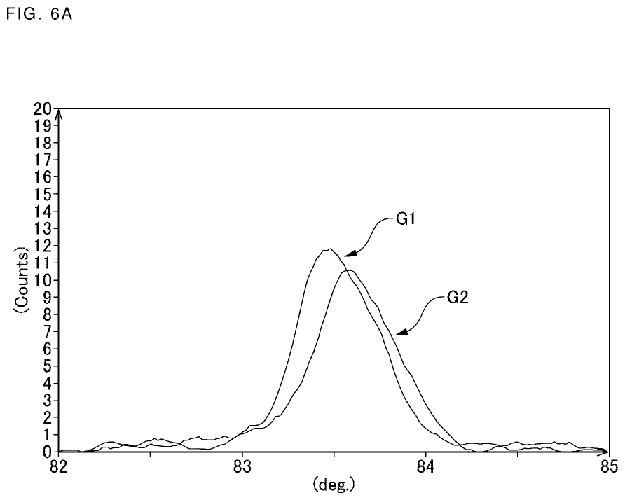

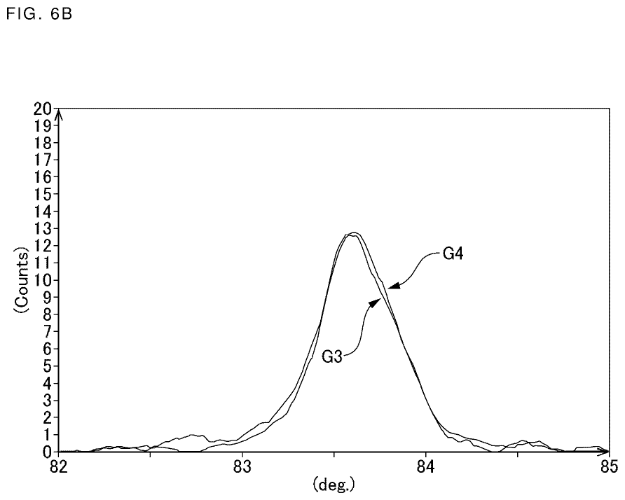

FIGS. 6A and 6B are graphs showing the peak diffraction angle in Examples of the second example embodiment and Comparative Examples of the second example embodiment. FIG. 6A illustrates the peak diffraction angle in Examples of the second example embodiment, and FIG. 6B illustrates the peak diffraction angle in Comparative Examples of the second example embodiment. FIGS. 6A and 6B each illustrate the peak diffraction angle at an azimuth angle of about 30 degrees and the peak diffraction angle at an azimuth angle of about 90 degrees.

Referring to FIGS. 6A and 6B, the difference between the first peak diffraction angle and the second peak diffraction angle is about 0.023 degrees or more in Examples of the second example embodiment. The difference between the first peak diffraction angle and the second peak diffraction angle is less than about 0.023 degrees in Comparative Examples of the second example embodiment.

TABLE 1

| | | | | | | | | Difference | |
|---|---|---|---|---|---|---|---|---|---|
| | | | | | | | | (degrees) in | |
| | | | | | | | | Peak | |
| | | | | | | | | Diffraction | |
| | | | | Number | | Peak Diffraction | | Angle Between | |
| | | | | of | Dielectric | Angle (degrees) | | Azimuth | |
| | Firing | Temperature | | Stacked | Layer | Azimuth | Angle: 30 | Angles of 90 | |
| | Temperature | After Cooling | Cooling | Layers | Thickness | Angle: 90 | Azimuth | Degrees and | Relative |
| | (degrees) | (degrees) | Conditions | (layers) | (μm) | Degrees | Degrees | 30 Degrees | Permittivity |
| Comparative | 1000 | 200 | natural | 300 | 1.0 | 83.598 | 83.590 | 0.008 | 3520 |
| Example 1 | | | cooling | | | | | | |
| Example 1 | 1000 | 200 | nitrogen gas | 300 | 1.0 | 83.573 | 83.550 | 0.023 | 3850 |
| | | | at 30 | | | | | | |
| | | | degrees, flow | | | | | | |
| | | | velocity: 10 | | | | | | |
| | | | m/s | | | | | | |
| Example 2 | 1000 | 200 | nitrogen gas | 300 | 1.0 | 83.579 | 83.517 | 0.062 | 3980 |
| | | | at 30 | | | | | | |
| | | | degrees, flow | | | | | | |
| | | | velocity: 20 | | | | | | |
| | | | m/s | | | | | | |
| Example 3 | 1000 | 200 | nitrogen gas | 300 | 1.0 | 83.610 | 83.530 | 0.080 | 4130 |
| | | | at 0 degrees, | | | | | | |
| | | | flow velocity: | | | | | | |
| | | | 10 m/s | | | | | | |
| Example 4 | 1000 | 200 | nitrogen gas | 300 | 1.0 | 83.570 | 83.485 | 0.085 | 4200 |
| | | | at 0 degrees, | | | | | | |
| | | | flow velocity: | | | | | | |
| | | | 20 m/s | | | | | | |

TABLE 2

| | | | | | | | | Difference | |
|---|---|---|---|---|---|---|---|---|---|
| | | | | | | | | (degrees) in | |
| | | | | | | | | Peak | |
| | | | | | | | | Diffraction | |
| | | | | Number | | Peak Diffraction | | Angle Between | |
| | | | | of | Dielectric | Angle (degrees) | | Azimuth | |
| | Firing | Temperature | | Stacked | Layer | Azimuth | Azimuth | Angles of 90 | |
| | Temperature | After Cooling | Cooling | Layers | Thickness | Angle: 90 | Angle: 30 | Degrees and | Relative |
| | (degrees) | (degrees) | Conditions | (layers) | (μm) | Degrees | Degrees | 30 Degrees | Permittivity |
| Comparative | 1000 | 200 | natural | 410 | 0.6 | 83.601 | 83.585 | 0.001 | 3500 |
| Example 2 | | | cooling | | | | | | |
| Example 5 | 1000 | 200 | nitrogen gas | 410 | 0.6 | 83.578 | 83.555 | 0.023 | 3800 |
| | | | at 30 | | | | | | |
| | | | degrees, flow | | | | | | |
| | | | velocity: 10 | | | | | | |
| | | | m/s | | | | | | |
| Example 6 | 1000 | 200 | nitrogen gas | 410 | 0.6 | 83.589 | 83.537 | 0.052 | 3910 |
| | | | at 30 | | | | | | |
| | | | degrees, flow | | | | | | |
| | | | velocity: 20 | | | | | | |
| | | | m/s | | | | | | |
| Example 7 | 1000 | 200 | nitrogen gas | 410 | 0.6 | 83.592 | 83.513 | 0.079 | 4010 |
| | | | at 0 degrees, | | | | | | |
| | | | flow velocity: | | | | | | |
| | | | 10 m/s | | | | | | |
| Example 8 | 1000 | 200 | nitrogen gas | 410 | 0.6 | 83.586 | 83.472 | 0.114 | 4250 |
| | | | at 0 degrees, | | | | | | |
| | | | flow velocity: | | | | | | |
| | | | 20 m/s | | | | | | |

Tables 1 and 2 show the relative permittivity and other properties in Examples of the second example embodiment and Comparative Examples of the second example embodiment. Table 1 shows the case where the number of stacked layers is 300 and the dielectric layer thickness is about 1.0 μm, and Table 2 shows the case where the number of stacked layers is 410 and the dielectric layer thickness is about 0.6 μm. In both cases, the relative permittivity in Examples of the second example embodiment is 3800 or more. The relative permittivity in Comparative Examples of the second example embodiment does not exceed 3800.

Therefore, a high relative permittivity can be achieved by setting the difference between the first peak diffraction angle and the second peak diffraction angle to about 0.023 degrees or more.

The dimensions of the multilayer ceramic capacitors of Examples of the second example embodiment and Comparative Examples of the second example embodiment are about 1.0 mm in the length direction L and about 0.5 mm in the width direction W and the height direction T. The number of stacked inner electrode layers is 300 or 410, and the thickness of the dielectric layers is about 0.60 μm or about 1 μm. The thickness of the inner electrode layers is about 0.5 μm.

### Measurement Method

The length, thickness, and other properties of each a portion can be measured, for example, as described below. The multilayer ceramic capacitor 1 is polished to a widthwise center position. The cross-section exposed by polishing is then observed with an optical microscope or other devices. The length, thickness, and other properties can be measured from the observed cross-section.

### Third Example Embodiment

A multilayer ceramic capacitor 1 of a third example embodiment of the present invention will be described. The following description focuses mainly on the differences from the first example embodiment. Matters not specifically described can be the same or substantially the same as those in the first example embodiment.

The technique described in Japanese Unexamined Patent Application Publication No. 2017-228590 may be insufficient to improve electrical characteristics or reliability. The third example embodiment is directed to a multilayer ceramic capacitor with higher relative permittivity.

A multilayer ceramic capacitor according to the third example embodiment includes a multilayer body including a plurality of stacked dielectric layers, a plurality of stacked inner electrode layers, a first main surface and a second main surface facing each other in a height direction, a first side surface and a second side surface facing each other in a width direction perpendicular or substantially perpendicular to the height direction, and a first end surface and a second end surface facing each other in a length direction perpendicular or substantially perpendicular to the height direction and the width direction, and an outer electrode layer on the multilayer body and connected to some of the inner electrode layers, wherein, when the dielectric layers are observed by high-angle annular dark-field scanning transmission electron microscopy, a plurality of (100) crystal planes are observed by positioning the optical axis of a microscope perpendicular or substantially perpendicular to an observation surface and tilting the observation surface by about −20 degrees or more and about +20 degrees or less from the plane perpendicular to the optical axis.

According to the multilayer ceramic capacitor of the third example embodiment, a multilayer ceramic capacitor with higher relative permittivity can be provided.

The detection of the (100) crystal planes of the crystal grains of the dielectric layers in the multilayer ceramic capacitor 1 of the third example embodiment will be described.

### (100) Crystal Plane

In the dielectric layers in the multilayer ceramic capacitor 1 of the third example embodiment, the probability of occurrence of the (100) crystal plane is high. The description is provided below based on the observation by high-angle annular dark-field scanning transmission electron microscopy (HAADF-STEM).

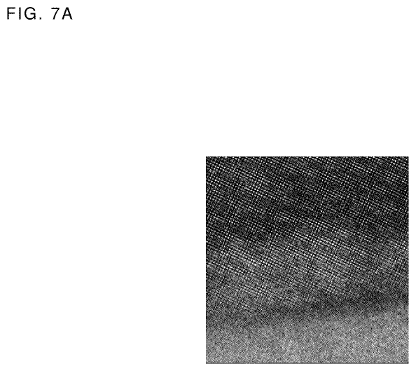

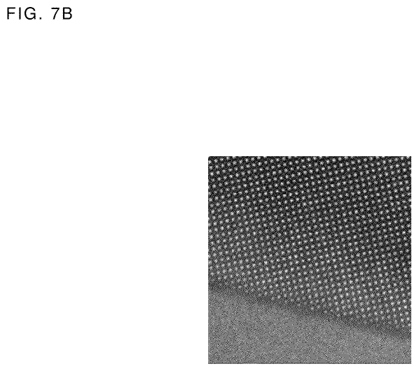

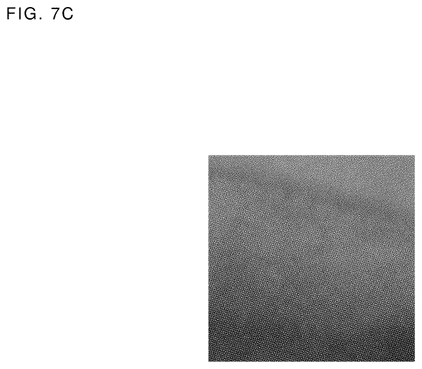

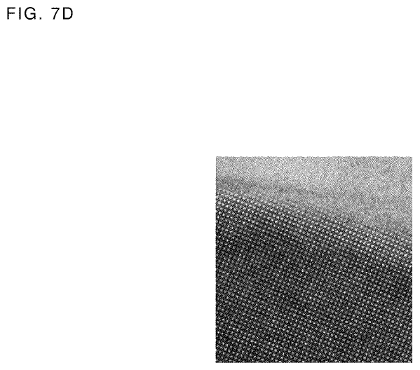

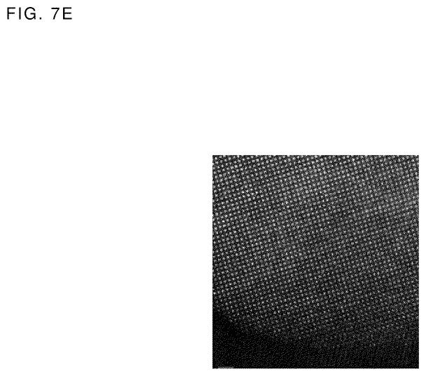

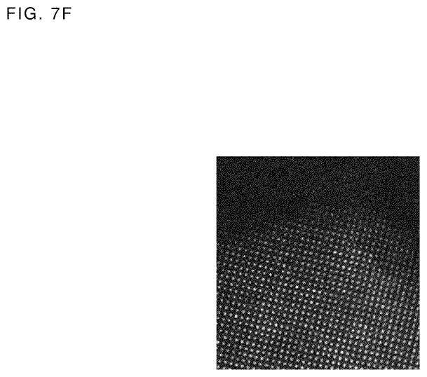

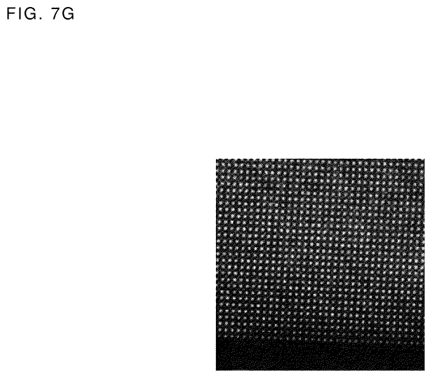

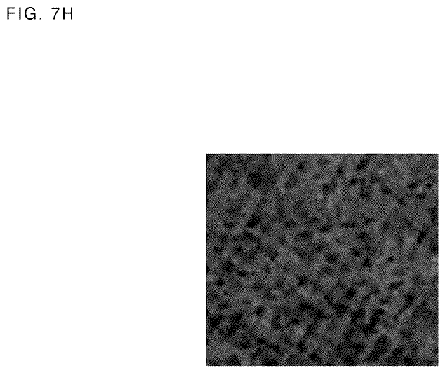

FIGS. 7A to 7G illustrate the observation results obtained by high-angle annular dark-field scanning transmission electron microscopy when the (100) crystal plane is observed. FIG. 7H illustrates the result when the (100) crystal plane is not observed. The observation surface is observed by high-angle annular dark-field scanning transmission electron microscopy while the observation surface is tilted.

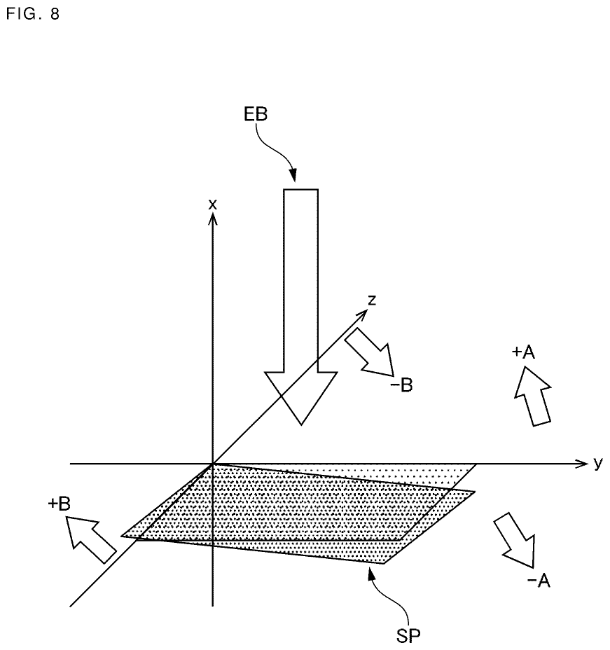

FIG. 8 illustrates how the observation surface is observed by high-angle annular dark-field scanning transmission electron microscopy. When the observation surface is provided in the YZ plane in the XYZ Cartesian coordinate system illustrated in FIG. 8, the electron beam in high-angle annular dark-field scanning transmission electron microscopy is directed from the positive side of the X-axis toward the negative side of the X-axis as indicated by arrow EB.

The observation surface provided in the YZ plane can be rotated about the Z-axis and rotated about the −Y axis. In FIG. 8, the rotation about the Y-axis is indicated by arrow A. The rotation about the Z-axis is indicated by arrow B.

For the rotation about the Y-axis, the angle of rotation is defined as angle α. The rotation in the positive direction of the X-axis is defined as rotation at angle α in the positive direction. For the rotation about the Z-axis, the angle of rotation is defined as angle β. The rotation in the positive direction of the X-axis is defined as rotation at angle β in the positive direction.

High-angle annular dark-field scanning transmission electron microscopy observation was conducted on the WT cross-section of the multilayer ceramic capacitor at the midpoint in the length direction T. The multilayer ceramic capacitor is polished to expose the WT cross-section. Polishing is performed by grinding the surface that is parallel or substantially parallel to the width direction W and the height direction T.

High-angle annular dark-field scanning transmission electron microscopy observation was performed using a thin section sample. More specifically, a thin section sample including the WT cross-section of the multilayer ceramic capacitor at the center position in the length direction T was prepared, and the WT cross-section of the thin section sample was observed. The thin section sample was prepared by polishing the surface opposite the WT cross-section to be observed to a sample thickness of, for example, about 70 μm.

The observation was conducted on a central a portion of a crystal grain. In barium titanate having a core-shell structure, the core portion is the target of observation.

FIG. 7A illustrates the (100) crystal plane observed when the observation surface is tilted by about 1.95 degrees in angle α and by about 0.27 degrees in angle β. Similarly, FIG. 7B illustrates the (100) crystal plane observed when the observation surface is tilted by about 9.84 degrees in angle α and by about 1.87 degrees in angle β, FIG. 7C illustrates it when tilted by about 9.06 degrees in angle α and by about 2.35 degrees in angle β, FIG. 7D illustrates it when tilted by about 0.96 degrees in angle α and by about −13.75 degrees in angle β, FIG. 7E illustrates it when tilted by about 9.21 degrees in angle α and by about 11.38 degrees in angle β, FIG. 7F illustrates it when tilted by about 17.59 degrees in angle α and by about 10.94 degrees in angle β, and FIG. 7G illustrates it when tilted by about 17.59 degrees in angle α and by about 6.38 degrees in angle β.

For the dielectric layers in the multilayer ceramic capacitor 1 of the third example embodiment, a plurality of (100) crystal planes can be observed by tilting the observation surface by about −20 degrees or more and about +20 degrees or less in angle α and by about −20 degrees or more and about +20 degrees or less in angle β.

In conventional multilayer ceramic capacitors, the (100) crystal plane cannot be observed by tilting the observation surface by about −20 degrees or more and about +20 degrees or less in angle α and by about −20 degrees or more and about +20 degrees or less in angle β. The observation result when the (100) crystal plane is not observed is as illustrated in FIG. 7H.

The multilayer ceramic capacitor 1 of the third example embodiment in which the (100) crystal planes can be observed by tilting the observation surface by about −20 degrees or more and about +20 degrees or less in angle α and by about −20 degrees or more and about +20 degrees or less in angle β achieves a higher permittivity than conventional multilayer ceramic capacitors.

FIGS. 7A to 7G illustrate the observation results of the central portion of a crystal grain. In the multilayer ceramic capacitor 1 of the third example embodiment, the (100) crystal plane was observed in the central a portion of a crystal grain, where the (100) crystal plane was difficult to observe.

In the multilayer ceramic capacitor 1 of the third example embodiment, the (100) crystal plane as described above is observed in both of two adjacent crystal grains.

As described above, in the multilayer ceramic capacitor 1 of the third example embodiment, the (100) crystal plane exists accurately without distortion and with high probability.

### Measurement Method

The length, thickness, and other properties of each a portion can be measured, for example, as described below. The multilayer ceramic capacitor 1 is polished to a widthwise center position. The cross-section exposed by polishing is then observed with an optical microscope or other devices. The length, thickness, and other properties can be measured from the observed cross-section.

### Fourth Example Embodiment

A multilayer ceramic capacitor 1 according to a fourth example embodiment of the present invention will be described. The following description focuses mainly on the differences from the first example embodiment. Matters not specifically described can be the same or substantially the same as those in the first example embodiment.

The technique described in Japanese Unexamined Patent Application Publication No. 2017-228590 may be insufficient to improve electrical characteristics or reliability. The fourth example embodiment is directed to a multilayer ceramic capacitor with higher relative permittivity.

A multilayer ceramic capacitor according to the fourth example embodiment includes a multilayer body including a plurality of stacked dielectric layers, a plurality of stacked inner electrode layers, a first main surface and a second main surface facing each other in a height direction, a first side surface and a second side surface facing each other in a width direction perpendicular or substantially perpendicular to the height direction, and a first end surface and a second end surface facing each other in a length direction perpendicular or substantially perpendicular to the height direction and the width direction, and an outer electrode layer on the multilayer body and connected to some of the inner electrode layers, wherein a value of second average grain size/first average grain size is about 1.0 or more, where the first average grain size is the median diameter of crystal grains in the dielectric layers determined by observation with a scanning transmission electron microscope, and the second average grain size is the median diameter of crystal grains each of which is deemed to be constituted by two adjacent crystal grains between which a misorientation angle is within about 5 degrees with respect to a predetermined direction when the crystal orientations of the crystal grains in the dielectric layers are measured by electron backscatter diffraction.

According to the multilayer ceramic capacitor of the fourth example embodiment, a multilayer ceramic capacitor with higher relative permittivity can be provided.

### Grain Size

The grain size of the crystal grains in the dielectric layers in the multilayer ceramic capacitor 1 of the fourth example embodiment will be described. In the dielectric layers in the multilayer ceramic capacitor 1 of the fourth example embodiment, the grain size determined based on the observation with a scanning transmission electron microscope is the same as or smaller than the grain size determined based on the crystal orientation map obtained by transmission EBSD.

The grain size of the crystal grains refers to the median diameter in the area particle size distribution. The median diameter is also referred to as d50.

To determine the grain size based on the crystal orientation map obtained by transmission EBSD, first, the crystal orientation of the crystal grains in the dielectric layers is measured by electron backscatter diffraction. When the difference in crystal orientation between two adjacent crystal grains is within 5 degrees with respect to a predetermined direction, these two adjacent crystal grains are deemed to constitute a single crystal grain. Therefore, as the number of two adjacent crystal grains between which the difference in crystal orientation is within 5 degrees with respect to a predetermined direction increases, the grain size determined based on the crystal orientation map obtained by the transmitted EBSD increases.

TABLE 3

| | | | | | Second Average | | |
|---|---|---|---|---|---|---|---|
| | | | | | Grain Size (μm) | | |
| | | | | First Average | (diameter of | Second | |
| | | | | Grain Size | regions whose | Average Grain | Relative |
| | | Dielectric Layer | Electrode | (μm) | misorientation | Size/First | Permittivity/First |
| | Cooling Time | Thickness | Thickness | (TEM grain | angles are within | Average Grain | Average Grain |
| Sample No. | (min) | (μm) | (μm) | size) | 5 degrees) | Size | Size (1/μm) |
| 1 | 7 | 0.55 | 0.6 | 250 | 250 | 1.0 | 14.2 |
| 2 | 7 | 0.55 | 0.6 | 270 | 270 | 1.0 | 13.8 |
| 3 | 2 | 0.55 | 0.6 | 204 | 231 | 1.1 | 15.2 |
| 4 | 2 | 0.55 | 0.6 | 276 | 284 | 1.0 | 18.6 |
| 5 | 2 | 0.55 | 0.6 | 280 | 324 | 1.2 | 18.9 |
| 6 | 1 | 0.55 | 0.6 | 360 | 380 | 1.1 | 23.1 |
| 7 | 1 | 0.55 | 0.6 | 320 | 330 | 1.0 | 22.0 |
| 8 | 0.5 | 0.55 | 0.6 | 285 | 360 | 1.3 | 24.6 |
| 9 | 160 | 0.55 | 0.6 | 241 | 202 | 0.8 | 11.9 |
| 10 | 15 | 0.55 | 0.6 | 308 | 251 | 0.8 | 11.8 |

Table 3 shows the cooling time after firing the multilayer ceramic capacitor, the grain size, and the relative permittivity. The first average grain size refers to the median diameter of the crystal grains in the dielectric layers determined based on observation with a scanning transmission electron microscope. The second average grain size refers to the median diameter of crystal grains each of which is deemed to be constituted by two adjacent crystal grains between which a misorientation angle is within about 5 degrees with respect to a predetermined direction when the crystal orientations are measured by electron backscatter diffraction.

Table 3 shows the value of the relative permittivity/the first average grain size, in addition to the first average grain size and the second average grain size. The value of the relative permittivity/the first average grain size indicates the relative permittivity per grain size. The larger this value is, the more preferable the electrical characteristics are. In samples where the second average grain size/the first average grain size is about 1 or more, the value of the relative permittivity/the first average grain size is about 13 or more. In other words, these samples provide preferable electrical characteristics.

The measurements shown in Table 3 were conducted on the WT cross-section of the multilayer ceramic capacitor at the midpoint in the length direction T. The multilayer ceramic capacitor is polished to expose the WT cross-section. Polishing is performed by grinding the surface that is parallel or substantially parallel to the width direction W and the height direction T.

The measurement by electron backscatter diffraction to obtain the crystal orientation map through transmission EBSD was performed using a thin section sample. The WT cross-section of the multilayer ceramic capacitor at the middle position in the length direction T, as described above, was processed into a thin section sample before the measurement. Specifically, the WT cross-section was measured after the surface opposite the measurement surface was polished to a sample thickness of about 100 nm.

The grain size was evaluated in a central a portion of the WT cross-section. The size of the evaluation area was about 2 μm square. In the electron backscatter diffraction, accurate values are not always obtained in, for example, regions where multiple crystal grains overlap each other in the direction perpendicular to the measurement surface. If the evaluation area includes a large proportion of such regions where accurate values are not obtained, accurate evaluation is difficult. The size of the evaluation area was thus set to about 2 μm square.

### Measurement Method

The length, thickness, and other properties of each a portion can be measured, for example, as described below. The multilayer ceramic capacitor 1 is polished to a widthwise center position. The cross-section exposed by polishing is then observed with an optical microscope or other devices. The length, thickness, and other properties can be measured from the observed cross-section.

Although example embodiments of the present invention are described above, the present invention is not limited to the above example embodiments, and various changes and variations are possible.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of stacked dielectric layers, a plurality of stacked inner electrode layers, a first main surface and a second main surface facing each other in a height direction, a first side surface and a second side surface facing each other in a width direction perpendicular or substantially perpendicular to the height direction, and a first end surface and a second end surface facing each other in a length direction perpendicular or substantially perpendicular to the height direction and the width direction; and
an outer electrode layer on the multilayer body and connected to some of the plurality of inner electrode layers;
when crystal orientations of crystal grains in the plurality of dielectric layers are measured by electron backscatter diffraction, in a 2 μm-square observation area, two or more pairs of adjacent crystal grains between which a difference in crystal orientation is within about 5 degrees with respect to a predetermined direction are present.

2. The multilayer ceramic capacitor according to claim 1, wherein 20 or more pairs of adjacent crystal grains between which a difference in crystal orientation is within about 5 degrees with respect to a predetermined direction are present.

3. The multilayer ceramic capacitor according to claim 1, wherein one or more sets of three crystal grains are present and include one crystal grain, and two crystal grains adjacent to the one crystal grain and whose misorientation angles with respect to the one crystal grain are within about 5 degrees.

4. The multilayer ceramic capacitor according to claim 1, wherein 50 or more and 250 or less crystal grains are observed in the observation area.

5. The multilayer ceramic capacitor according to claim 1, wherein each of the plurality of dielectric layers includes barium titanate, calcium titanate, strontium titanate, or calcium zirconate as a main component.

6. The multilayer ceramic capacitor according to claim 1, wherein each of the plurality of dielectric layers includes a perovskite oxide including an A-site element and a B-site element as a main component.

7. The multilayer ceramic capacitor according to claim 1, wherein a thickness of each of the plurality of dielectric layers is about 0.3 μm or more and about 10 μm or less.

8. The multilayer ceramic capacitor according to claim 1, wherein each of the plurality of inner electrode layers includes nickel, copper, silver, palladium, or gold.

9. A multilayer ceramic capacitor comprising:
a multilayer body including a plurality of stacked dielectric layers, a plurality of stacked inner electrode layers, a first main surface and a second main surface facing each other in a height direction, a first side surface and a second side surface facing each other in a width direction perpendicular or substantially perpendicular to the height direction, and a first end surface and a second end surface facing each other in a length direction perpendicular or substantially perpendicular to the height direction and the width direction; and
an outer electrode layer on the multilayer body and connected to some of the plurality of inner electrode layers; wherein
when crystal orientations of crystal grains in the plurality of dielectric layers are measured by electron backscatter diffraction, about 2% or more of all crystal grains are crystal grains each of which is in contact with another crystal grain whose difference in crystal orientation from the corresponding crystal grain is within about 5 degrees with respect to a predetermined direction.

10. The multilayer ceramic capacitor according to claim 9, wherein about 20% or more of all crystal grains are crystal grains each of which is in contact with another crystal grain whose difference in crystal orientation from the corresponding crystal grain is within about 5 degrees with respect to a predetermined direction.

11. The multilayer ceramic capacitor according to claim 9, wherein each of the plurality of dielectric layers includes barium titanate, calcium titanate, strontium titanate, or calcium zirconate as a main component.

12. The multilayer ceramic capacitor according to claim 9, wherein each of the plurality of dielectric layers includes a perovskite oxide including an A-site element and a B-site element as a main component.

13. The multilayer ceramic capacitor according to claim 9, wherein a thickness of each of the plurality of dielectric layers is about 0.3 μm or more and about 10 μm or less.

14. The multilayer ceramic capacitor according to claim 9, wherein each of the plurality of inner electrode layers includes nickel, copper, silver, palladium, or gold.

15. A multilayer ceramic capacitor comprising:
a multilayer body including a plurality of stacked dielectric layers, a plurality of stacked inner electrode layers, a first main surface and a second main surface facing each other in a height direction, a first side surface and a second side surface facing each other in a width direction perpendicular or substantially perpendicular to the height direction, and a first end surface and a second end surface facing each other in a length direction perpendicular or substantially perpendicular to the height direction and the width direction; and
an outer electrode layer on the multilayer body and connected to some of the plurality of inner electrode layers; wherein
a value of second average grain size/first average grain size is about 1.0 or more;
where the first average grain size is a median diameter of crystal grains in the plurality of dielectric layers determined by observation with a scanning transmission electron microscope, and the second average grain size is a median diameter of crystal grains each defining two adjacent crystal grains between which a misorientation angle is within about 5 degrees with respect to a predetermined direction when crystal orientations of the crystal grains in the dielectric layers are measured by electron backscatter diffraction.

16. The multilayer ceramic capacitor according to claim 15, wherein each of the plurality of dielectric layers includes barium titanate, calcium titanate, strontium titanate, or calcium zirconate as a main component.

17. The multilayer ceramic capacitor according to claim 15, wherein each of the plurality of dielectric layers includes a perovskite oxide including an A-site element and a B-site element as a main component.

18. The multilayer ceramic capacitor according to claim 15, wherein a thickness of each of the plurality of dielectric layers is about 0.3 μm or more and about 10 μm or less.

19. The multilayer ceramic capacitor according to claim 15, wherein each of the plurality of inner electrode layers includes nickel, copper, silver, palladium, or gold.
